(19) United States
(12) Patent Application Publication
(10) Pub. No.: US 2018/0138485 A1
(43) Pub. Date: May 17, 2018

(54) WIRING MODULE AND POWER STORAGE MODULE

(71) Applicants: AutoNetworks Technologies, Ltd., Yokkaichi, Mie (JP); Sumitomo Wiring Systems, Ltd., Yokkaichi, Mie (JP); SUMITOMO ELECTRIC INDUSTRIES, LTD., Osaka-shi, Osaka (JP)

(72) Inventors: Osamu NAKAYAMA, Yokkaichi, Mie (JP); Seishi KIMURA, Yokkaichi, Mie (JP)

(21) Appl. No.: 15/580,007

(22) PCT Filed: Jun. 8, 2016
(86) PCT No.: PCT/JP2016/067024

§ 371 Date: Dec. 6, 2017

(30) Foreign Application Priority Data
Jun. 24, 2015 (JP) 2015-126745

(51) Int. Cl. H01M 2/20; H01M 2/10; H01M 10/48; H01R 31/02

(52) U.S. Cl. CPC H01M 2/206; H01M 2/1077; H01M 2220/20; H01R 31/02; H01M 10/482

(57) ABSTRACT

A wiring module includes: plate-shaped connection members that connect adjacent positive and negative electrode terminals of a plurality of power storage elements that include the electrode terminals; holding portions that hold the connection members; and detection terminals that are arranged overlapping with the connection members and are configured to detect states of the power storage elements. The detection terminals can be welded to the connection members using a welding means arranged on a side opposite to the connection members. The holding portions are provided with welding protection portions that are arranged on surfaces opposite to surfaces on which the detection terminals are arranged, in regions of the connection members overlapped by the detection terminals, in a state in which the connection members are held in the holding portions.

### TECHNICAL FIELD

The technique disclosed in the present specification relates to a wiring module and a power storage module.

### BACKGROUND ART

A vehicle such as an electric automobile or a hybrid automobile is provided with a battery module constituted by connecting multiple battery cells in series or in parallel. This type of battery module includes a wiring module that connects electrode terminals of adjacent battery cells. The wiring module includes bus bars made of metal that connect the adjacent electrode terminals and insulating bus bar holding members that hold the bus bars. Also, voltage detection wires for detecting voltages of battery cells are connected to the electrode terminals of the battery cells in some cases.

For example, a configuration in which a detection terminal is crimped to a terminal of the voltage detection wire and the detection terminal is jointly fastened together with the bus bar to an electrode terminal is known as a configuration for connecting a voltage detection wire to an electrode terminal.

### CITATION LIST

### Patent Documents

Patent Document 1: JP 2013-16382A

### SUMMARY OF INVENTION

### Technical Problem

Incidentally, regarding the connection between the bus bar and the electrode terminal, a connection method using laser welding instead of fastening with a bolt, a nut, or the like has been proposed. However, if this kind of connection method is employed, a dedicated fastening member for the detection terminal will be needed in order to fix the detection terminal having the above-described configuration to the bus bar, and thus the number of parts will increase and a separate fixing task will also be necessary.

In view of this, it is conceivable that the connection of the detection terminal and the bus bar is also performed through welding such as laser welding, for example, instead of through fastening using a bolt, a nut, or the like. If the bus bar and the electrode terminal are connected through laser welding, for example, the laser welding of the detection terminal and the bus bar can be performed in a series of task steps using the laser welding equipment, and therefore the connection task can be simplified.

However, if the connection of the detection terminal and the bus bar is performed through welding, there is a risk that the surface on the opposite side of the bus bar will be influenced and a defect such as deforming the battery cell will be caused.

The technique disclosed in the present specification was completed based on the foregoing circumstances and aims to provide a wiring module that can suppress an adverse influence on a power storage element even if a detection terminal and a connection member are connected through welding.

### Solution to Problem

The technique disclosed in the present specification as a solution to the above-described problem is a wiring module including: plate-shaped connection members that connect adjacent positive and negative electrode terminals of a plurality of power storage elements that include the electrode terminals; holding portions that hold the connection members; and detection terminals that are arranged overlapping with the connection members and are configured to detect states of the power storage elements, and the wire module is characterized in that the detection terminals can be welded to the connection members using a welding means arranged on a side opposite to the connection members, and the holding portions are provided with welding protection portions that are arranged on surfaces opposite to surfaces on which the detection terminals are arranged, in regions of the connection members overlapped by the detection terminals, in a state in which the connection members are held in the holding portions.

According to the above configuration, when the detection terminals and the connection members are connected, even if the surfaces of the connection members opposite to the surfaces on which the detection terminals are arranged are influenced, a case in which the power storage elements are also influenced is suppressed by the welding protection portions.

The welding protection portions may be molded integrally with the holding portions. With this kind of configuration, the welding protection portions can be provided easily, and the manufacturing cost can be suppressed compared to the configuration in which the welding protection portions are provided separately from the holding portions.

The detection terminals may be voltage detection terminals configured to detect voltages of the power storage elements.

Also, the technique disclosed in the present specification is a power storage module obtained by attaching the above-described wiring module to a plurality of power storage elements.

### Advantageous Effects of Invention

With the technique disclosed in the present specification, it is possible to provide a wiring module and a power storage module according to which it is possible to suppress a case in which a power storage element is adversely influenced, even if a detection terminal is connected to a connection member through welding.

### BRIEF DESCRIPTION OF DRAWINGS

FIG. 1 is a plan view of a power storage element group according to an embodiment.

FIG. 2 is a plan view of a bus bar.

FIG. 3 is a plan view of an insulating protector.

FIG. 4 is a cross-sectional view taken along line A-A in FIG. 3.

FIG. 5 is a plan view of a voltage detection terminal.

FIG. 6 is a side view of the voltage detection terminal.

FIG. 7 is a plan view of a state in which bus bars are housed in the insulating protector.

FIG. 8 is a cross-sectional view taken along line B-B in FIG. 7.

FIG. 9 is a cross-sectional view taken along line C-C in FIG. 7.

FIG. 10 is a plan view of a state in which voltage detection terminals are arranged on the insulating protector.

FIG. 11 is a cross-sectional view taken along line D-D in FIG. 10.

FIG. 12 is a partially-enlarged cross-sectional view of FIG. 11.

FIG. 13 is a cross-sectional view taken along line E-E in FIG. 10.

FIG. 14 is a cross-sectional view of a power storage module.

### DESCRIPTION OF EMBODIMENTS

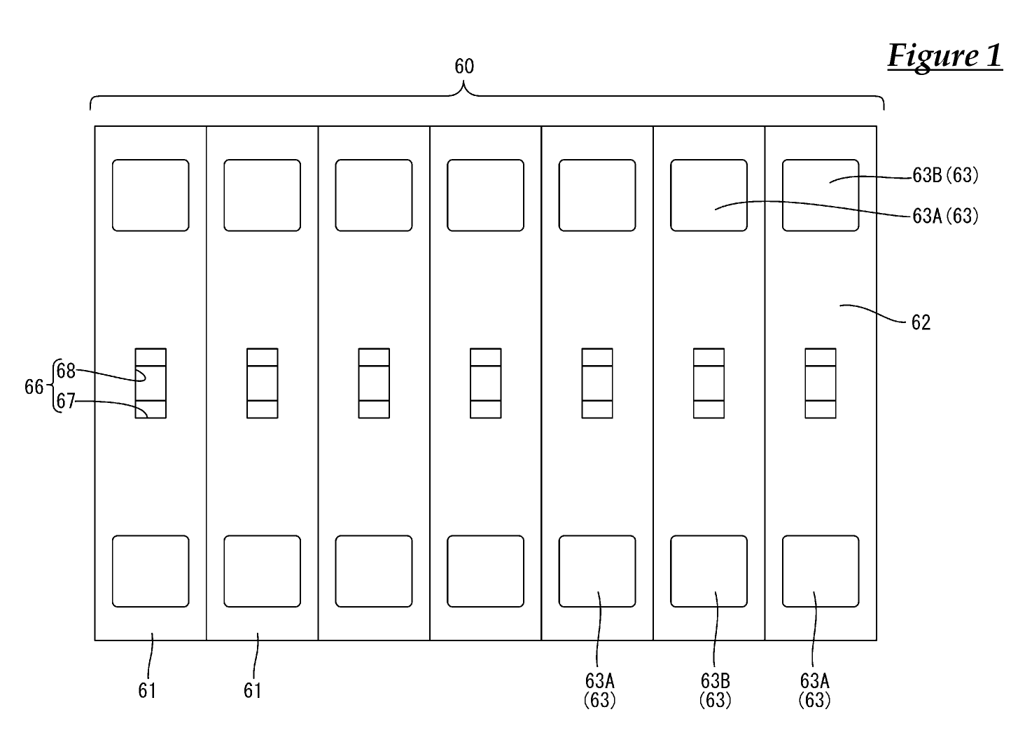

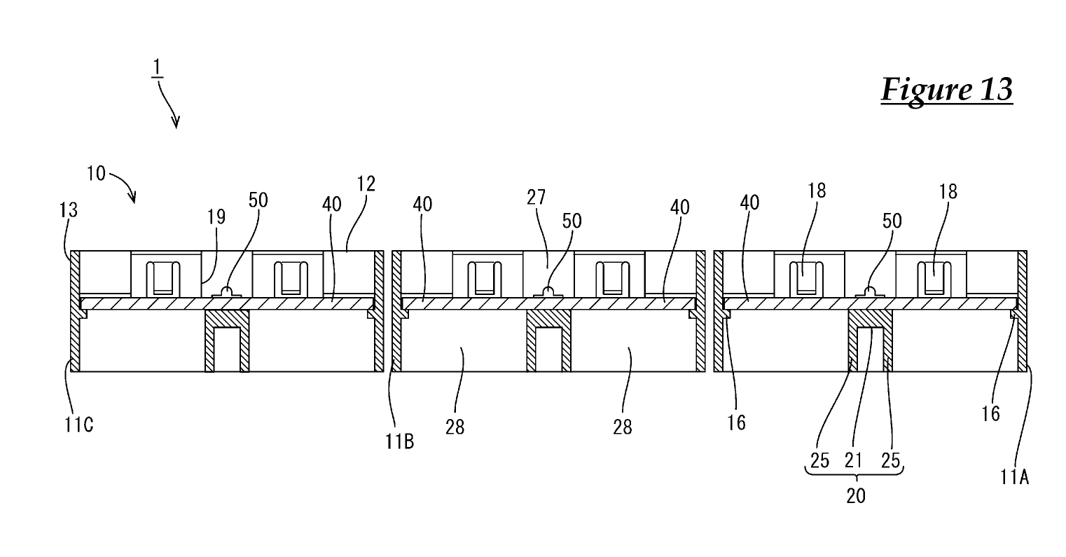

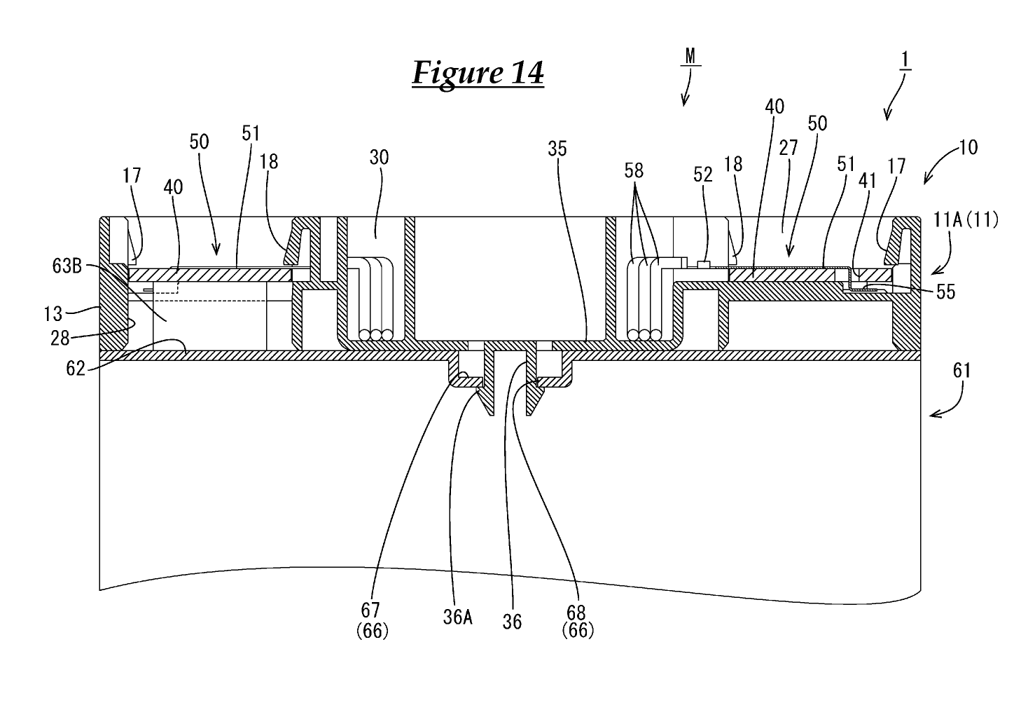

An embodiment will be described with reference to FIGS. 1 to 14. As shown in FIG. 1, a power storage module 1 of the present embodiment forms a power storage module M due to being attached to a power storage element group 60 that is constituted by aligning multiple power storage elements 61. The power storage module M is mounted in a vehicle (not shown) such as an electric automobile or a hybrid automobile and is used as a power source for driving the vehicle.

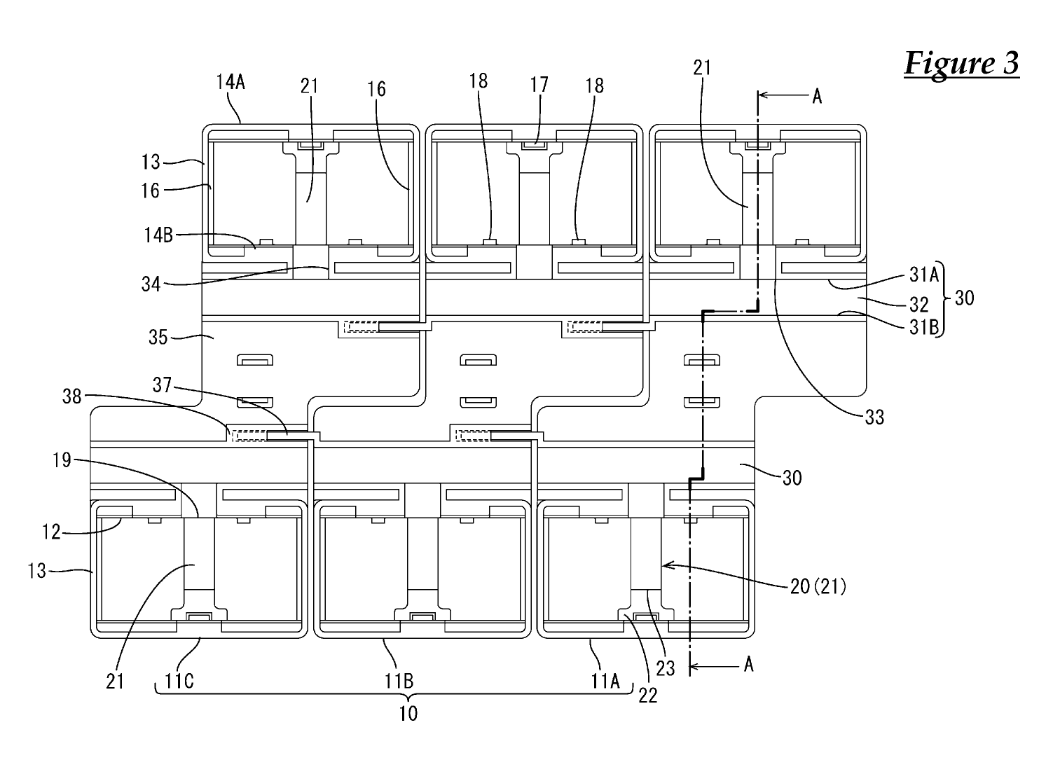

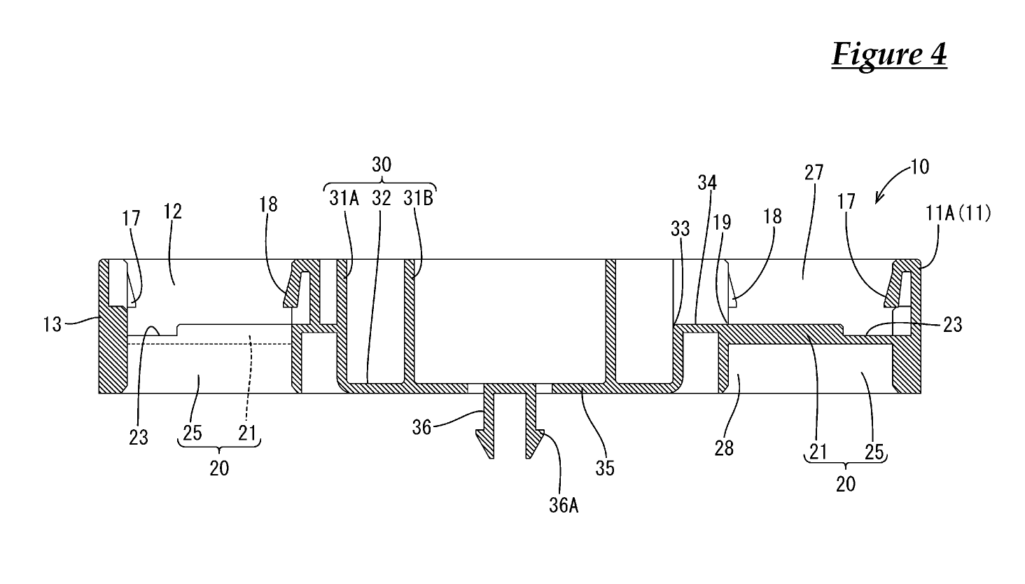

Note that in the following description, description will be given with the upper portion of FIG. 4 set as upward, the lower portion set as downward, the left side of FIG. 3 set as left, and the right side set as right. Also, if there are multiple identical members, one member is denoted by a reference sign and other members are not.

### Power Storage Element Group 60 and Power Storage Elements 61

The power storage elements 61 of the present embodiment are secondary batteries. As shown in FIG. 1, multiple power storage elements 61 are aligned in a row to form the power storage element group 60.

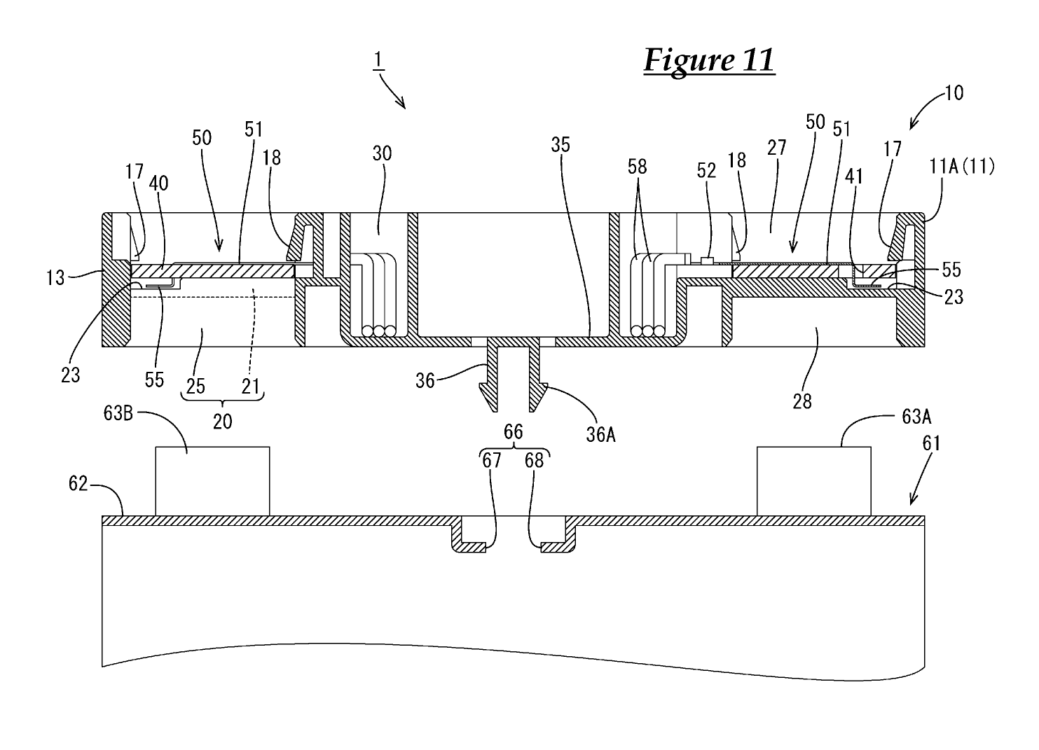

The outer shapes of the power storage elements 61 are flat cuboid shapes, and as shown in FIG. 1, each power storage element 61 has an electrode arrangement surface 62 that is orthogonal to the surfaces opposing the adjacent power storage elements 61. A pair of electrode terminals 63 are arranged at positions near the two end portions in the lengthwise direction on the electrode arrangement surface 62. One of the electrode terminals 63 is a cathode terminal 63A and the other is an anode terminal 63B. The electrode terminals 63 are made of metal and protrude from the electrode arrangement surfaces 62 in rectangular cylindrical shapes (see FIG. 11).

A locked portion 66 for locking a locking piece 36 of a later-described insulating protector 10 is provided between the pair of electrode terminals 63 of one power storage element 61. The locked portion 66 has a form in which a hole portion 68 is provided in the central portion of a recessed portion 67 that is depressed in a recessed shape from the electrode arranged surface 62 (see FIGS. 1 and 11).

The multiple power storage elements 61 are aligned such that electrode terminals 63 with different polarities are adjacent to each other in two adjacent power storage elements 61 (in other words, such that the cathode terminal 63A of one power storage element 61 and the anode terminal 63B of another power storage element 61 adjacent thereto are adjacent to each other).

### Wiring Module 1

The wiring module 1 is a member that is attached to the surface constituted by the electrode arrangement surfaces 62 of the power storage elements 61 in the power storage group 60. The wiring module 1 includes an insulating protector 10, bus bars 40 (an example of connection members) that are held in the insulating protector 10 and connect the cathode terminals 63A and the anode terminals 63B of the adjacent power storage elements 61, voltage detection elements 50 that are arranged overlapping with the bus bars 40 and are electrically connected thereto, and detection wires 58 that are connected to the voltage detection elements 50.

### Bus Bar 40

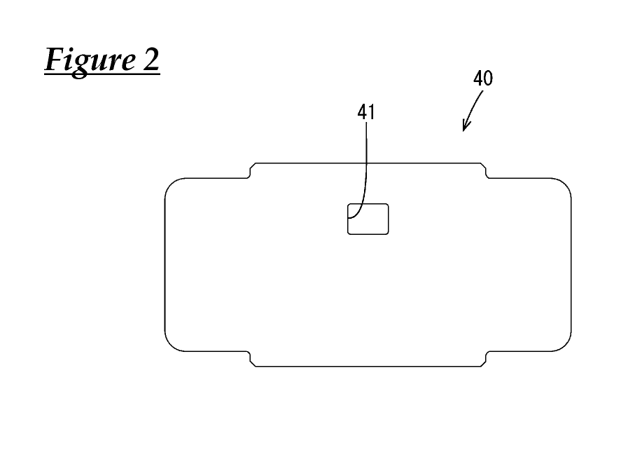

The bus bar 40 is formed by punching out a metal plate, and as shown in FIG. 2, the bus bar 40 is an overall approximately rectangular plate-shaped member whose four corners are cut out in flat rectangular shapes. Examples of the material of the bus bar 40 include copper, a copper alloy, aluminum, an aluminum alloy, and stainless steel (SUS).

In the bus bar 40, a rectangular locking hole 41 for locking an insertion portion 55 of the later-described voltage detection terminal 50 is formed penetrating through the plate surface in the center in the lengthwise direction (the left-right direction in FIG. 2) and slightly toward one end side with respect to the central portion of the width direction recess (the up-down direction in FIG. 2).

### Insulating Protector 10

The insulating protector 10 of the present embodiment is constituted by coupling multiple coupling units 11. In the present embodiment, three coupling units 11A, 11B, and 11C are aligned in the alignment direction of the multiple power storage elements 61. In the following description, the first coupling unit 11A is the coupling unit 11 that is arranged on the right end in FIG. 3, the second coupling unit 11B is the coupling unit 11 that is arranged adjacent thereto (in the center), and the third coupling unit 11C is the coupling unit 11 that is arranged on the left end. Also, in a case where no distinction is made between the first coupling unit 11A, the second coupling unit 11B, and the third coupling unit 11C, description will be given using the coupling unit 11.

As shown in FIG. 4, one coupling unit 11 includes a pair of bus bar holding portions 12 (an example of holding portions) that are open in the vertical direction and house and hold the bus bars 40, and a pair of wire housing grooves 30 for housing detection wires 58 that are connected to the voltage detection terminals 50 arranged overlapping with the bus bars 40.

The bus bar holding portion 12 includes a rectangular tube-shaped housing wall 13 inside of which the bus bar 40 is held and kept in a state of being insulated from adjacent bus bars 40, and the housing wall 13 is constituted by a pair of long walls 14 and a pair of short walls 15 that couple the pair of long walls 14. The dimensions of the pairs of long walls 14 and short walls 15 are set to be dimensions according to which the pair of electrode terminals 63 arranged adjacent to each other can be housed inside of the housing wall 13. The housing wall 13 functions also as a protection wall for the adjacent electrode terminals 63.

A pair of housing walls 13 provided in one coupling unit 11 are arranged such that the long walls 14 oppose each other in a parallel state, and so as to be shifted in the extension direction (left-right direction in FIG. 3) of the long walls 14 by a dimension corresponding to one electrode terminal 63. Hereinafter, among the four long walls 14 of one coupling unit 11, the pair of long walls 14 that are located on the outer sides (the upper side and lower side in FIG. 3) are outer-side long walls 14A, and the pair of long walls 14 that are located on the inner sides (between the pair of outer-side long walls 14A) are inner-side long walls 14B.

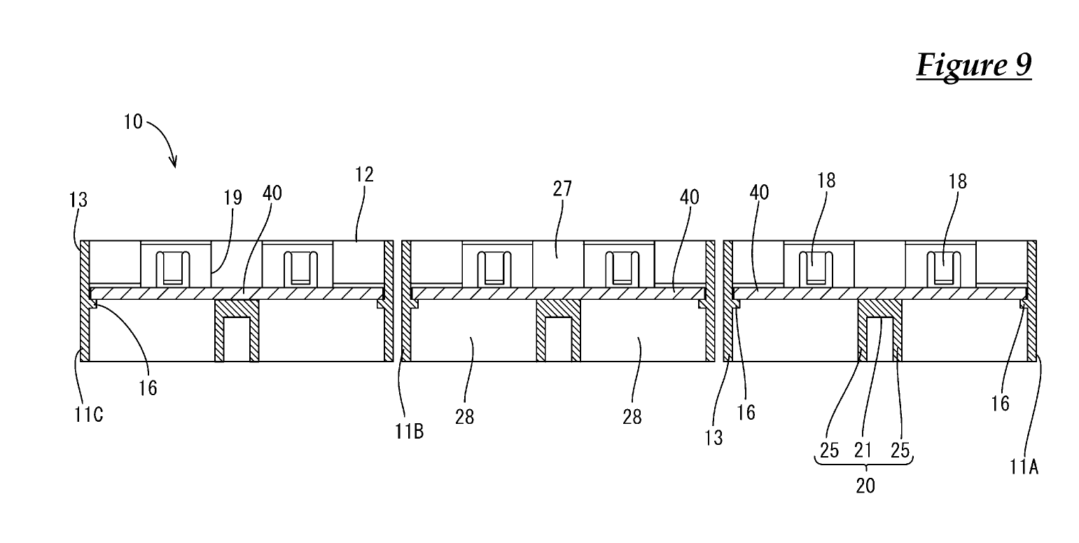

Mounting portions 16 that protrude toward the inner side of the housing wall 13 spanning over the entire region in the width direction (the vertical direction in FIG. 3) of the short walls 15 are provided in the approximate central portions in the width direction of the pair of short walls 15. This pair of mounting portions 16 support the two end portions in the lengthwise direction of the bus bar 40 housed in the housing wall 13 from below (see FIG. 9).

Also, a first retaining piece 17 that retains the bus bar 40 housed in the housing wall 13 from above is provided in the central portion in the lengthwise direction of the outer-side long wall 14A. On the other hand, a pair of second retaining pieces 18 that similarly retain the bus bar 40 housed in the housing wall 13 from above are provided slightly toward the two end portions with respect to the central portion in the lengthwise direction of the inner-side long wall 14B. The first retaining piece 17 and the second retaining pieces 18 have flat spring shapes that extend diagonally downward from the upper end portions of the long walls 14 toward the inside of the housing wall 13, and can elastically deform in the direction of moving toward or away from the long walls 14.

A wire guiding port 19 for guiding a detection wire 58 connected to a later-described voltage detection terminal 50 toward a wire housing groove 30 is formed between the pair of second retaining pieces 18 (in the center in the lengthwise direction of the long walls 14) on the inner-side long wall 14B. The wire guiding port 19 is continuous with a groove-shaped barrel holding groove 34 that couples the bus bar holding portion 12 and the later-described wire housing groove 30.

The bus bar holding portion 12 of the present embodiment is provided with a welding protection portion 20. The welding protection portion 20 is arranged so as to bridge between the outer-side long wall 14A and the inner-side long wall 14B in the center in the lengthwise direction (the left-right direction in FIG. 3).

More specifically, the welding protection portion 20 has a U-shaped cross-section as shown in FIG. 9, and includes an elongated band-shaped protection wall 21 that extends over the plate surface in the vertical direction and a pair of hang-down walls 25 that extend downward from the two side edges of the protection wall 21.

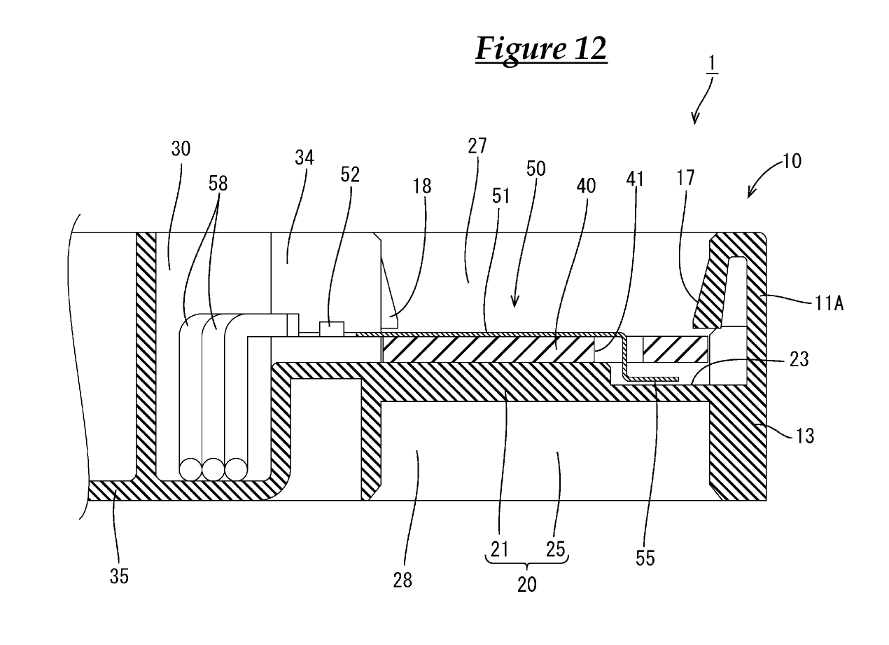

The end portion of the protection wall 21 on the outer-side long wall 14A side is used as a wide portion 22 with a plate width dimension that is wider than at other portions. Also, as shown in FIG. 4, the region near the end portion of the protection wall 21 on the outer-side long wall 14A side is one step lower due to the upper surface being cut off in a step shape over the end region in the width direction, and the lower portion is used as a relief recessed portion 23 that allows the insertion portion 55 of the later-described voltage detection terminal 50 to pass. Note that the engaging hole 41 of the above-described bus bar 40 is set such that at least a portion thereof is arranged at a position corresponding to the relief recessed portion 23 (see FIG. 12).

The width dimension of the region of the protection wall 21 other than the wide portion 22 is set to be a dimension that is slightly smaller than the width dimension between the adjacent electrode terminals 63. In other words, it is set to be a dimension according to which the welding protection portion 20 (the pair of hang-down walls 25) are fit between adjacent electrode terminals 63. Also, as shown in FIG. 9, the upper surface of the region of the protection wall 21 other than the relief recessed portion 23 is set to be the same height as that of the upper surface of the above-described mounting portion 16. Furthermore, the lower end surfaces of the hang-down walls 25 are set to be the same height as the lower end surface of the housing wall 13.

The welding protection portion 20 is molded integrally with the insulating protector 10 (the bus bar holding portion 12).

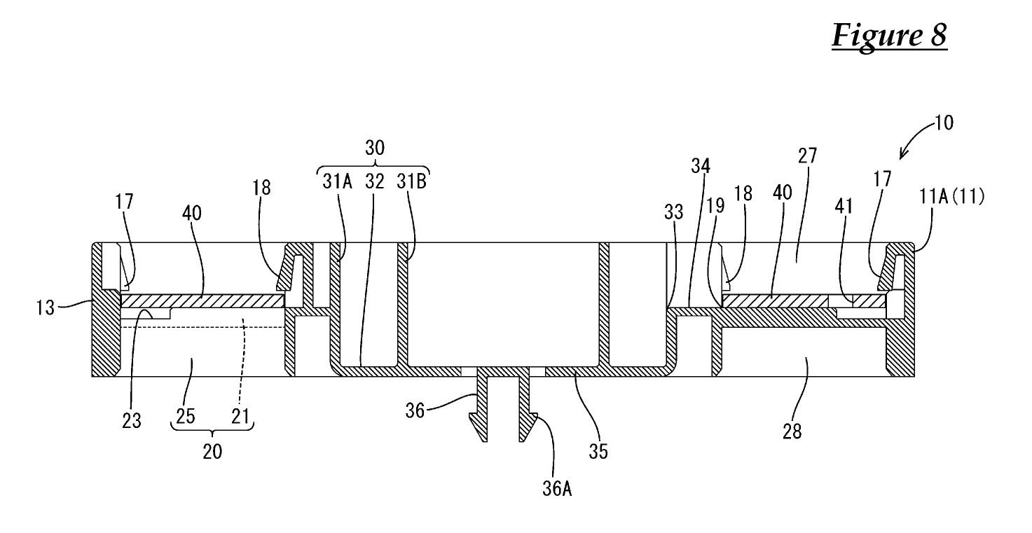

Also, the bus bar holding portion 12 is functionally divided into two portions in the vertical direction by the welding protection portion 20. The upper side of the two portions is a bus bar housing portion 27 that houses the bus bar 40, and the lower side is a pair of electrode housing portions 28 that house the electrode terminals 63 (see FIGS. 8 and 9).

The pair of wire housing grooves 30 each include a pair of groove walls 31 and a bottom portion 32, and are provided between the pair of bus bar holding portions 12 in one coupling unit 11 so as to be adjacent to the bus bar holding portions 12 and so as to extend in the lengthwise direction (the left-right direction in FIG. 3) of the bus bar holding portion 12. A wire inlet 33 that is continuous with the barrel holding groove 34 and through which the detection wire 58 that is pulled out from the bus bar holding portion 12 is introduced into the wire housing groove 30 is formed in the groove wall portion 31A on the bus bar holding portion 12 side of the pair of groove wall portions 31.

The pair of wire housing grooves 30 provided in one coupling unit 11 are coupled by a coupling portion 35. The coupling portion 35 is a plate-shaped member that couples the lower edges of the groove wall portions 31B of the pair of wire housing grooves 30 (see FIG. 4). As described above, since the pair of bus bar holding portions 12 are arranged shifted by a dimension corresponding to one electrode terminal 63 in the lengthwise direction, the coupling portions 35 extended from the groove wall portions 31B are coupled shifted by a dimension corresponding to one electrode terminal 63 in the left-right direction in FIG. 3. Accordingly, the coupling portions 35 are approximately Z-shaped overall in plan view.

A pair of locking pieces 36 that protrude downward are provided at positions corresponding to the locked portion 66 of the power storage elements 61 in a state in which the insulating protector 10 is assembled in the power storage element group 60 in the coupling portion 35. Locking protruding portions 36A that protrude outward are provided on the lower end portion of the locking pieces 36, and the insulating protector 10 is fixed to the power storage element group 60 due to the locking protruding portions 36A being locked to the edge portions of the hole portion 68 of the locked portions 66.

Also, the coupling portion 35 is provided with a unit engagement portion 37 and/or a unit engagement receiving portion 38 for coupling with an adjacent coupling unit 11.

Here, to give a description with a distinction made between the coupling units 11, the first coupling unit 11A is provided with a pair of plate-shaped unit engagement portions 37 that extend toward the second coupling unit 11B from the side edge located on the second coupling unit 11B side among the pair of side edges of the coupling unit 35. The unit engagement portion 37 has engagement claws on its leading end, although this is not shown in detail in the drawing.

Also, the coupling portion 35 of the second coupling unit 11B is provided with a portion with a greater plate thickness at a position corresponding to the unit engagement portions 37 of the first coupling unit 11A, and this portion is provided with recessed unit engagement reception portions 38 that can receive the unit engagement portions 37 of the first coupling unit 11A. The unit engagement reception portions 38 include protruding pieces with which the engagement claws of an adjacent coupling unit 11 are engaged, although this is not shown in detail in the drawings.

Also, the side edge located on the third coupling unit 11C side among the pair of side edges of the coupling portion 35 of the second coupling unit 11B is provided with a pair of unit engagement portions 37 that are similar to the unit engagement portions 37 of the first coupling unit 11A.

Furthermore, the side edge located on the second coupling unit 11B side among the pair of side edges of the coupling portion 35 of the third coupling unit 11C is provided with a pair of unit engagement reception portions 38 that are similar to the unit engagement reception portions 38 of the second coupling unit 11B, at positions corresponding to the unit engagement portions 37 of the second coupling unit 11B.

Due to the unit engagement portions 37 and the unit engagement reception portions 38 of the coupling units 11 engaging with each other, the adjacent coupling units 11 are coupled to each other and the insulating protector 10 is formed.

### Voltage Detection Terminal 50

The voltage detection terminal 50 is for detecting the voltage of the power storage element 61 and is electrically connected to the electrode terminal 63 of the power storage element 61 via the bus bar 40. The voltage detection terminal 50 is formed by pressing a metal plate material such as copper, a copper alloy, stainless steel, or aluminum into a predetermined shape. The surface of the voltage detection terminal 50 may be plated with a metal such as tin or nickel.

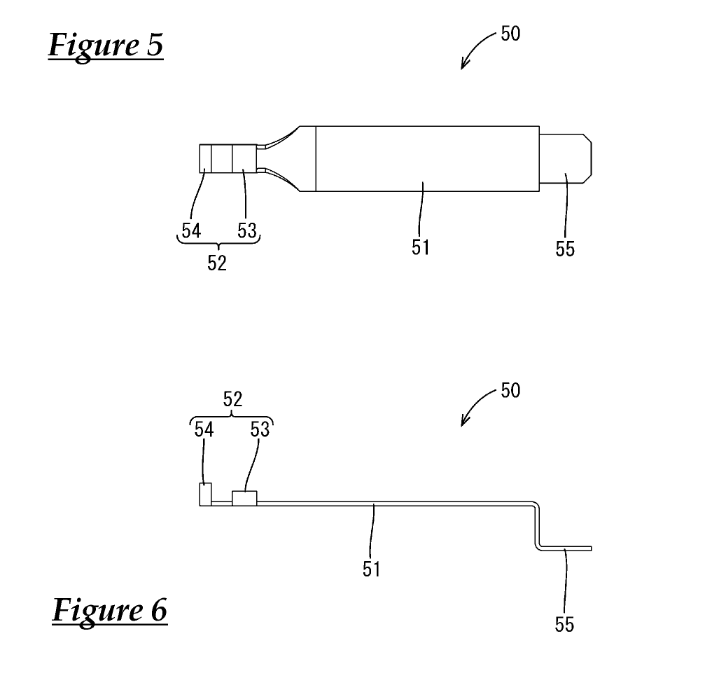

As shown in FIGS. 5 and 6, the voltage detection terminal 50 of the present embodiment includes a plate-shaped terminal main body portion 51 that has an elongated rectangular shape, and a wire connection portion 52 that extends in the lengthwise direction of the terminal main body portion 51. The width dimension of the terminal main body portion 51 is set to be a dimension that is equal to or slightly smaller than being equal to the width dimension of the protection wall 21. The wire connection portion 52 includes a wire barrel 53 that is provided adjacent to the terminal main body portion 51 and is crimped to an exposed core wire of the detection wire 58, and an insulation barrel 54 that is provided aligned with the wire barrel 53 and is crimped to the insulation covering of the detection wire 58, and the wire connection portion 52 is formed so as to stand upright in one direction from one surface side of the terminal main body portion 51.

An insertion portion 55 for locking the voltage detection terminal 50 by being inserted into the locking hole 41 of the above-described bus bar 40 is extended in a crank shape on the edge portion of the terminal main body portion 51 on the side opposite to the wire connection portion 52 so as to protrude toward the opposite side in the standing direction of the wire connection portion 52.

The voltage detection terminal 50 is electrically connected to a detection wire 58 by being crimped such that the wire barrel 53 of the wire connection portion 52 wraps around the core wire of the detection wire 58. Also, the voltage detection terminal 50 is bonded to the bus bar 40 through laser welding. The end portion on the side opposite to the detection wire 58 is connected to an ECU or the like (not shown), and the voltage of the power storage element 61 is detected by the ECU or the like.

### Method for Assembling Power Storage Module M

When the power storage module M of the above-described present embodiment is to be assembled, first, the multiple coupling units 11 are coupled to each other. Specifically, the pair of unit engagement portions 37 of the second coupling unit 11B are engaged with the pair of unit engagement reception portions 38 of the third coupling unit 11C that is adjacent thereto. Accordingly, the second coupling unit 11B and the third coupling unit 11C are coupled. The insulating protector 10 is assembled by attaching the remaining first coupling unit 11A to the second coupling unit 11B using a similar procedure (see FIG. 3).

Note that a clearance is set between the leading ends of the unit engagement portions 37 and the far ends of the unit engagement reception portions 38, and the adjacent coupling units 11 are attached to as to be displaceable in a direction in which the adjacent coupling units 11 move toward or away from each other by an amount corresponding to the clearance. Accordingly, when the wiring module 1 (the insulating protector 10) is attached to the power storage element group 60, shifting of the pitch between the adjacent electrode terminals 63 caused by a manufacturing allowance of the power storage elements 61 and an attachment allowance of the multiple aligned power storage elements 61 can be absorbed.

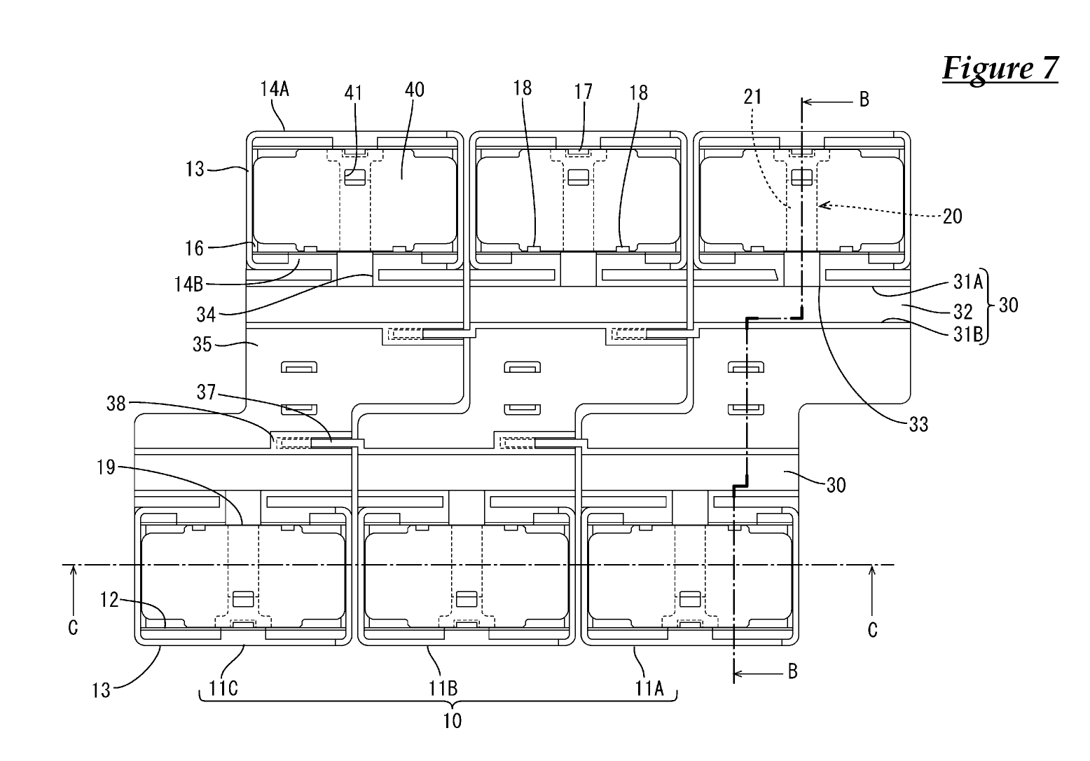

Next, the bus bar 40 is housed in the bus bar holding portion 12 of the insulating protector 10. The bus bar 40 is pushed downward while being guided by the housing wall 13 of the bus bar holding portion 12, and when the bus bar 40 comes into contact with the first retaining piece 17 and the second retaining pieces 18, the retaining pieces 17 and 18 are elastically deformed downward and the bus bar 40 advances further downward. Then, when the bus bar 40 is pushed past the first retaining piece 17 and the second retaining pieces 18, the bus bar 40 is held in a retained state in which it is pressed down from above due to the first retaining piece 17 and the second retaining pieces 18 elastically reverting (see FIGS. 7 to 9).

The bus bar 40 housed in the bus bar holding portion 12 is supported from below due to the two end portions in the lengthwise direction thereof being mounted on the pair of mounting portions 16 and the central portion in the lengthwise direction is supported from below by the welding protection portion 20 (protection wall 21). In other words, the bus bar 40 is put in a state in which the regions of the underside surface (lower surface) that are located between the mounting portions 16 and the protection wall 21 are exposed to the downward side.

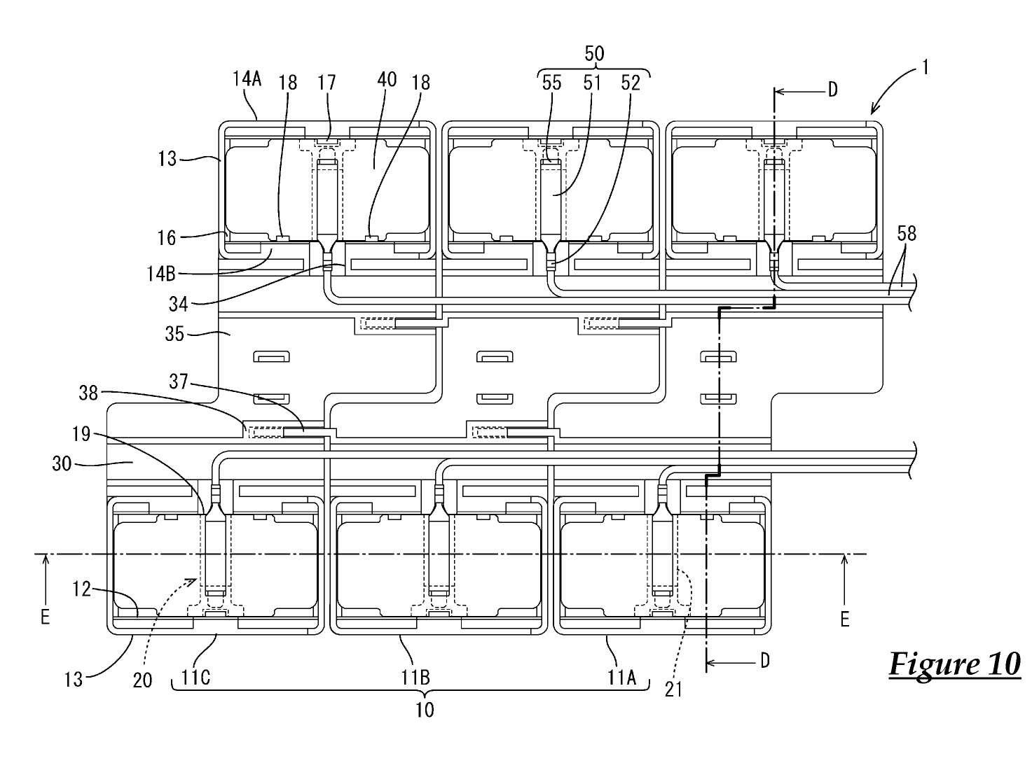

Next, the voltage detection terminal 50 is attached to the insulating protector 10. Specifically, the wire barrel 53 of the voltage detection terminal 50 is crimped to the end portion of the exposed core wire of the detection wire 58, an insulation barrel 54 is crimped to the insulation covering, and the terminal main body portion 51 is caused to overlap with the bus bar 40 by being housed from above at a predetermined location of the bus bar holding portion 12 (see FIGS. 10 to 13).

At the time of performing the overlapping task, first, the voltage detection terminal 50 is brought close to the bus bar 40 while slightly tilted such that the insertion portion 55 is located below, and after the insertion portion 55 is inserted into the locking hole 41 of the bus bar 40, the wire connection portion 52 side is caused to overlap with the bus bar 40. At this time, although the protection wall 21 is arranged on the lower surface side of the locking hole 41 of the bus bar 40, the relief recessed portion 23 is formed in the protection wall 21, and therefore the insertion portion 55 does not interfere with the protection wall 21.

Also, at the same time as the terminal main body portion 51 is overlapped with the bus bar 40, the wire connection portion 52 of the voltage detection terminal 50 is housed in the barrel holding groove 34. Then, the detection wire 58 guided from the wire connection portion 52 is arranged in the wire housing groove 30.

In this state, the voltage detection terminal 50 is held in a state of being positioned at a predetermined position in the bus bar holding portion 12.

The thus-assembled wire module 1 of the present invention is attached to the electrode arrangement surface 62 of the power storage element group 60. Specifically, the locking pieces 36 of the insulating protector 10 are inserted into the recessed portions 67 of the power storage elements 61 and the locking protruding portions 36A are locked on the hole edges of the hole portions 68. Upon doing so, the housing walls 13 surround the adjacent pairs of electrode terminals 63, and the pairs of hang-down walls 25 of the welding protection portions 20 are fit between the adjacent electrode terminals 63. In other words, the electrode terminals 63 are housed in the pairs of electrode terminal housing portions 28 of the bus bar holding portions 12. Also, the leading end portions (upper surfaces) of the electrode terminals 63 come into contact with the lower surfaces of the bus bars 40 that are exposed downward. In this state, a laser is emitted by a laser emission apparatus (not shown) (an example of a welding means) that is arranged above the wiring module 1 (on the side of the voltage detection terminal 50 that is opposite to the bus bar 40), the bus bars 40 and the electrode terminals 63 are welded through laser welding, and the terminal main body portions 51 of the voltage detection terminals 50 and the bus bars 40 are welded through laser welding. Thus, the power storage module M is completed (see FIG. 14).

### Effects of the Present Embodiment

Next, actions and effects of the present embodiment will be described.

In the present embodiment, a configuration is used in which the welding protection portion 20 is arranged on the lower surface side (the surface opposite to the surface on which the voltage detection terminal 50 is arranged) of the region of the bus bar 40 that is laser-welded to the voltage detection terminal 50. Accordingly, even if the underside surface of the bus bar 40 is influenced by the laser during laser welding, due to the welding protection portion 20, a case is suppressed in which the power storage element 61 is influenced, and a defect such as the power storage elements 61 deforming does not occur.

Also, since the welding protection portion 20 is molded integrally with the insulating protector 10 (the bus bar holding portion 12), the welding protection portion 20 can easily be provided, and it is possible to suppress the manufacturing cost in comparison to the configuration in which the welding protection portion 20 is provided separately from the insulating protector 10.

### Other Embodiments

The technique disclosed in the present specification is not limited to the embodiment described in the above description and drawings, and for example, the following embodiments are encompassed in the technical scope as well.

(1) In the above-described embodiment, an example was given in which the bus bar 40 and the voltage detection terminal 50 are laser-welded, but it is possible to apply the technique disclosed in the present specification also to a case of performing welding through another welding means, such as arc welding.

(2) In the above-described embodiment, a configuration was used in which the welding protection portion 20 is composed of a protection wall 21 and a pair of hang-down walls 25, but the welding protection portion 20 is not limited to the above-described configuration. For example, instead of providing the pair of hang-down walls 25, one thick plate-shaped member may be used, or a configuration may be used in which only a protection wall 21 without the pair of hang-down walls 25 is present. Also, the welding protection portion 20 does not need to bridge the housing wall 13 (the pair of long walls 14), and one side thereof need not be coupled to a long wall 14. In short, it is sufficient to provide the portion of the bus bar 40 that protects the underside surface of the region overlapped by the voltage detection terminal 50.

(3) In the above-described embodiment, an example was given in which the welding protection portion 20 is molded integrally with the insulating protector 10 (the bus bar protection portion 12), but the welding protection portion 20 may be formed separately.

(4) In the above-described embodiment, a relief recessed portion 23 was provided on the upper surface of the protection wall 21, but if the voltage detection terminal 50 does not include the insertion portion 55, the relief recessed portion 23 is not needed.

(5) In the above-described embodiment, an example was given in which the voltage detection terminal 50 is welded to the bus bar 40, but the technique disclosed in the present specification can be applied also to a case of welding another detection terminal, such as a current detection terminal or a temperature detection terminal.

(6) In the above-described embodiment, an example was given in which a secondary battery is used as the power storage element 61, but the technique disclosed in the present specification can be applied also to a laminate-type of power storage element group 60.

(7) In the above-described embodiment, the insulating protector 10 included three coupling units 11A, 11B, and 11B, but the insulating protector 10 may be obtained by coupling two or four or more coupling units 11. Also, three or more bus bar holding portions 12 may be provided in one coupling unit 11. Alternatively, the insulating protector 10 may be constituted by one member.

(8) In the above-described embodiment, an example was given in which the bus bar 40 and the electrode terminal 63 are laser-welded, but the technique disclosed in the present specification can be applied also to a wiring module with a configuration in which connection is performed through fastening of bolts and nuts.

### LIST OF REFERENCE NUMERALS

1 Wiring module

10 Insulating protector

11 Coupling unit

12 Bus bar holding portion (holding portion)

20 Welding protection portion

21 Protection wall

25 Hang-down wall

30 Wire housing groove

40 Bus bar (connection member)

50 Voltage detection terminal (detection terminal)

58 Detection wire

60 Power storage element group

61 Power storage element

63 Electrode terminal

63A Cathode terminal

63B Anode terminal

M Power storage module

1. A wiring module comprising:
plate-shaped connection members that connect adjacent positive and negative electrode terminals of a plurality of power storage elements that include the electrode terminals;
holding portions that hold the connection members; and
detection terminals that are arranged overlapping with the connection members and are configured to detect states of the power storage elements,
wherein the detection terminals can be welded to the connection members using a welding means arranged on a side opposite to the connection members, and
the holding portions are provided with welding protection portions that are arranged on surfaces opposite to surfaces on which the detection terminals are arranged, in regions of the connection members overlapped by the detection terminals, in a state in which the connection members are held in the holding portions.

2. The wiring module according to claim 1, wherein the welding protection portions are molded integrally with the holding portions.

3. The wiring module according to claim 1, wherein the detection terminals are voltage detection terminals configured to detect voltages of the power storage elements.

4. A power storage module in which the wiring module according to claim 1 is mounted on the plurality of power storage elements.
